(19) United States
(12) Patent Application Publication
(10) Pub. No.: US 2009/0047502 A1
(43) Pub. Date: Feb. 19, 2009

(54) NANO-ENHANCED MODULARLY CONSTRUCTED COMPOSITE PANEL

(75) Inventors: Robert Folaron, Plano, TX (US); James Wylde, Oak Leaf, TX (US); Tobin Djerf, Grand Saline, TX (US)

Correspondence Address: FIALA & WEAVER, P.L.L.C.;C/O INTELLEVATE, P.O. BOX 52050, MINNEAPOLIS, MN, 55402, US

(73) Assignee: SMART NANOMATERIALS, LLC, Plano, TX (US)

(21) Appl. No.: 12/189,684

(22) Filed: Aug. 11, 2008

Related U.S. Application Data
(60) Provisional application No. 60/955,453, filed on Aug. 13, 2007.

(51) Int. Cl. B32B 5/16; B29C 47/08; B29C 33/38; B32B 37/10; B32B 37/14

(52) U.S. Cl. 428/327; 156/244.24; 156/245; 156/280; 156/78; 977/773

(57) ABSTRACT

Methods and systems for modularly constructed panels are described. A panel is formed by stacking and attaching together multiple layers of one or more materials. A layer of a panel may be formed completely of a single material, such as a polymer material, or of a combination of materials. One or more layers of a panel may include one or more nanomaterials.

This application claims the benefit of U.S. Provisional Application No. 60/955,453, filed on Aug. 13, 2007, which is incorporated by reference herein in its entirety.

### CROSS-REFERENCE TO OTHER APPLICATIONS

The following applications of common assignee are related to the present application, were filed on the same date as the present application, and are herein incorporated by reference in their entireties:

U.S. application Ser. No. ______, titled “Nano-Enhanced Smart Panel,” and U.S. application Ser. No. ______, titled “Nano-Enhanced Modularly Constructed Container.”

### BACKGROUND OF THE INVENTION

1. Field of the Invention

The present invention relates to the construction of composite panels, and more particularly to modularly constructed composite panels enhanced with nanomaterials.

2. Background Art

A need exists for lightweight durable materials. Such durable materials may be needed for various reasons, such as a need to provide resistance to mechanical, thermal, chemical, and/or other environmental phenomena, and/or to address further requirements for durability. A wide variety of applications may benefit from materials that have such durability. Examples of such applications include vehicles, shipping and storage containers, aircraft skins, clothing (e.g., armor worn by security, law enforcement, military, and/or other personnel), structural applications, and further applications.

Applications that require movement of materials would benefit from materials having a decreased weight. For instance, items such as vehicles (e.g., delivery trucks, trains, etc.), shipping and storage containers, protective doors, and wind turbine blades require the expenditure of energy for the purpose of movement, and therefore would benefit from lighter weight materials.

Thus, what is desired are materials that are lightweight and durable, and that may be used in a variety of applications.

### BRIEF SUMMARY OF THE INVENTION

Methods, systems, and apparatuses for panels of material are described. The panels are modularly formed. For example, a panel may be modularly formed by combining multiple layers of one or more materials. A layer of a panel may be formed completely of a single material (i.e., a homogeneous layer), such as a polymer material. Alternatively, a layer may be formed of a first material combined with one or more further materials (e.g., a heterogeneous layer). Furthermore, the material of a layer may be enhanced with one or more nanomaterials.

Modular panels are described herein. In an example implementation, a modular polymer panel includes a plurality of layers attached together in a stack. At least one of the layers includes a polymer, and at least one of the layers includes a nanomaterial.

Method for forming modular panels are provided. A plurality of layers is formed. At least one layer of the plurality of layers is formed to include a nanomaterial. At least one layer of the plurality of layers is formed to include a polymer. The plurality of layers is arranged in a stack. The layers are attached together in the stack to form the panel.

Layers of the panel may be formed in various ways. For instance, a layer may be formed as a planar layer of the polymer. A layer may include a ribbon formed from the polymer. A plurality of ribbons may be woven together to form a layer. A plurality of fibers of the polymer may be woven together to form a layer. A plurality of yarn structures may be formed from a plurality of fibers of the polymer, and the yarn structures may be woven together to form a layer of the plurality of layers. A layer may be formed from a plurality of solid and/or hollow rods.

In another example, a first polymer material may be inserted into a mold. A catalyst material may be added to the first polymer material to cause a foam material to be produced that conforms to the shape of the mold. The foam material may be cured to generate a layer of the plurality of layers.

Furthermore, one or more rods or a woven material may be included in the mold. The foam material may be enabled to substantially surround the one or more rods or the woven material that are include in the mold. A layer is thereby generated that includes the cured foam material and the one or more rods or the woven material.

The layers in the stack may be attached together in various ways, including by a thermoforming technique, a compression molding process, generating and curing a foam material between a pair of adjacent layers in the stack, by positioning and heating thin sheets of thermoplastic adhesive between layers in the stack, and/or according to further adhesive materials and/or attachment techniques.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a perspective view of a fiber, according to an example embodiment of the present invention.

FIG. 2 shows a perspective view of a group of fibers, according to an example embodiment of the present invention.

FIGS. 3-5 show perspective views of example ribbons, according to embodiments of the present invention.

FIGS. 6-8 show perspective views of example planar layers, according to embodiments of the present invention.

FIGS. 9-12 show perspective views of example woven layers, according to embodiments of the present invention.

FIG. 13 shows a perspective exploded view of a layer that includes rods, according to an embodiment of the present invention.

FIG. 14 shows a perspective side view of the layer of FIG. 13, in assembled (non-exploded) form, according to an embodiment of the present invention.

FIG. 15 shows a perspective side view of a layer that includes rods, according to an example embodiment of the present invention.

FIG. 16 shows a cross-sectional view of a layer that includes rods, according to an example embodiment of the present invention.

FIG. 17 shows a perspective exploded view of a layer having multiple co-planar layer sections, according to an example embodiment of the present invention.

FIG. 18 shows a perspective side view of the panel of FIG. 17, in non-exploded form, according to an embodiment of the present invention.

FIG. 19 shows a perspective exploded view of a panel, according to an embodiment of the present invention.

FIG. 20 shows a side perspective view of the panel of FIG. 19, in non-exploded form, according to an example embodiment of the present invention.

FIG. 21 shows a flowchart for fabricating a panel, according to an example embodiment of the present invention.

FIG. 22 shows a block diagram of a panel fabrication system, according to an embodiment of the present invention.

FIG. 23 shows an example process for fabricating layers, according to an embodiment of the present invention.

FIG. 24 shows a block diagram of a layer fabricator, according to an example embodiment of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

### EXAMPLE EMBODIMENTS

The example embodiments described herein are provided for illustrative purposes, and are not limiting. Further structural and operational embodiments, including modifications/alterations, will become apparent to persons skilled in the relevant art(s) from the teachings herein.

Methods and systems for panels of material are described. In embodiments, a panel may be assembled that is lightweight, while being stiff or flexible (as desired for a particular application), strong, and tough. The panel may be modularly formed. In embodiments, a panel is modularly formed by combining multiple layers of one or more materials. In an embodiment, a layer of a panel may be formed completely of a single material (i.e., a homogeneous layer), such as a polymer material. For example, a layer may be formed of a thermoplastic or thermosetting plastic material. In another embodiment, the layer is formed of a first material (e.g., a polymer material) combined with one or more further materials (e.g., to form a heterogeneous layer).

Examples of such further materials are micro-scale and/or nano-scale technologies, component, and/or materials. As used herein, a nanoscale material or “nanomaterial” is a structure having at least one region or characteristic dimension with a dimension of less than 1000 nm. Examples of nanomaterials, including NEMS (nanoelectromechanical systems) devices and NST (nanosystems technology) devices, are described throughout this document. As used herein, a microscale material or device is a structure having at least one region or characteristic dimension with a dimension in the range of 1 micrometer (μm) to 1000 μm. Examples of microscale materials and devices, including MEMS (microelectromechanical systems) devices and MST (microsystems technology) devices, are described throughout this document.

For instance, in an embodiment, the material of a layer may be enhanced with one or more nanomaterials. The nanomaterials can vary in size, concentration, orientation, make-up (type), and/or mixture, as desired for a particular application. For example, nanomaterials such as nanowires, nanotubes, nanorods, nanoparticles (e.g., nanocrystals), etc., may be used to enhance the material of a layer, such as to strengthen the material, to harden the material, or to otherwise modify properties of the layer. Any type of nanotube may be used, including single-walled nanotubes and multi-walled nanotubes. Example types of nanoparticles include organic nanoparticles, such as fullerenes (e.g., buckyballs), graphite, other carbon nanoparticles, nano-platelets, and inorganic nanoparticles, such as particles formed by titanium (Ti), titanium oxide (TiO), or nano-clay. Further types of nanomaterials not mentioned herein may also be used, as would be known to persons skilled in the relevant art(s).

The introduction of nanomaterials into panel embodiments can provide numerous benefits. Many nanomaterials have beneficial properties, including strength, stiffness, and hardness. Carbon nanotubes are one of the strongest and stiffest materials known in terms of tensile strength and elastic modulus. A single-wall carbon nanotube is a sheet of graphite (graphene) that is one atom thick, and is rolled in a cylinder with diameter of the order of a nanometer. A carbon nanotube may have a length-to-diameter ratio that exceeds 10,000. Multi-walled carbon nanotubes have been tested to have a tensile strength in the order of 63 GPa, which is much greater than that for high-carbon steel, having a tensile strength of approximately 1.2 GPa. Because carbon nanotubes have a low density for a solid (1.3-1.4 g/cm³), the specific strength of carbon nanotubes (e.g., 48,462 kN·m/kg) is extremely high, compared to that for high-carbon steel (e.g., 154 kN·m/kg). Furthermore, polymerized single walled nanotubes are comparable to diamond in terms of hardness, but are less brittle. Thus, in applications requiring durable materials such as ballistic armor, incorporating nanomaterials in layers of panels can provide benefits in strength, stiffness, and hardness, among other benefits. The concentration and types of nanomaterials formed in a layer can be selected as desired for a particular application.

In an embodiment, a layer may be formed as a planar sheet of a material. In another embodiment, a layer may be formed from, or may include fibers, woven fibers and/or ribbons of material. In an embodiment, a layer may be a “foam” layer or may include a foam-based material. For example, a foam layer may be formed by applying a suitable material (e.g., a liquid or gel such as a polyurethane) between two solid layers of material (e.g., a polymer material), or into a mold, and causing the material to foam and harden/cure. For example, the material may be a combination of two or more materials that cure when mixed together. The material of the foam layer may have further materials (e.g., nanomaterials, fibers, ribbons, woven fibers, woven ribbons, etc.) dispersed within the foam layer prior to hardening, to provide the benefits of the further materials to the foam layer.

The panels may be modularly configured in any way, by combining layers, as desirable for a particular application. For example, layers may be stacked to form a panel. In another example, a panel may be formed by weaving together sub-layers. In still another example, one or more woven and/or one or more non-woven layers may be stacked to form a panel. The layers that form the panels may be rigid or flexible. When the layers are flexible, the formed panels may also be flexible. Such flexibility may be desirable for damping a velocity of received projectiles in ballistic armor or similar applications. Likewise, panels formed to be stiffer may be desirable for providing structural integrity to panels in a variety of applications. Any number of layers (and type) can be stacked in a panel to provide a desired level of durability, resistance to projectiles, hardness, etc.

Panels can be formed to be flat, curved, contoured (e.g., to match a desired surface), or otherwise formed in any geometric shape. For instance, in an embodiment, the layers of the panel may be shaped prior to being attached together to form the panel. In another embodiment, the panel may be shaped during the process of attaching the layers together. For instance, the layers may be placed in a mold in a manner that the layers conform to a predetermined shape of the mold, and an adhesive material between the layers may be cured/dried to attach the layers together in the predetermined shape. For example, a panel may be formed by a plurality of layers joined together during a monolithic process, where a foam material is formed between layers to join them together. Such a process may be used to form a panel prior to shaping of the panel, or may be performed in a mold chamber so that the panel is formed in the shape predetermined by the mold chamber. In another embodiment, the panel may be shaped after the layers are attached together to form the panel. For instance, a formed panel may be bent into a desired shape, may be cut into multiple pieces that may be reassembled (e.g., using any of nails, screws, bolts, an adhesive material, etc.) into a desired shape or structure (e.g., a container, body armor, etc.), etc.

Panels formed according to embodiments of the present invention have many applications. For example, panels may be incorporated in clothing, or may be formed to perform as clothing (e.g., shirts, pants, etc.), including outerwear (e.g., coats, jackets, etc.). Having one or more panels incorporated in or as clothing enables greater clothing durability. For example, in an embodiment, panels may be worn as ballistic armor by personnel in military and law enforcement applications. For example, the panels may be incorporated in bullet-proof vests, and/or other types of body armor. Panels can also be incorporated into armor used to protect objects, such as vehicles, dwellings, enclosures, etc.

Example embodiments for layer materials, layers, panels, and processes and systems for assembling the same, are described in the following subsections.

Example Layers and Layer Material Embodiments

Example embodiments for layers and for layer materials are described in this section. Such example embodiments are provided for purposes of illustrations, and are not intended to be limiting. Further structural and operational embodiments, including modifications/alterations, will become apparent to persons skilled in the relevant art(s) from the teachings herein.

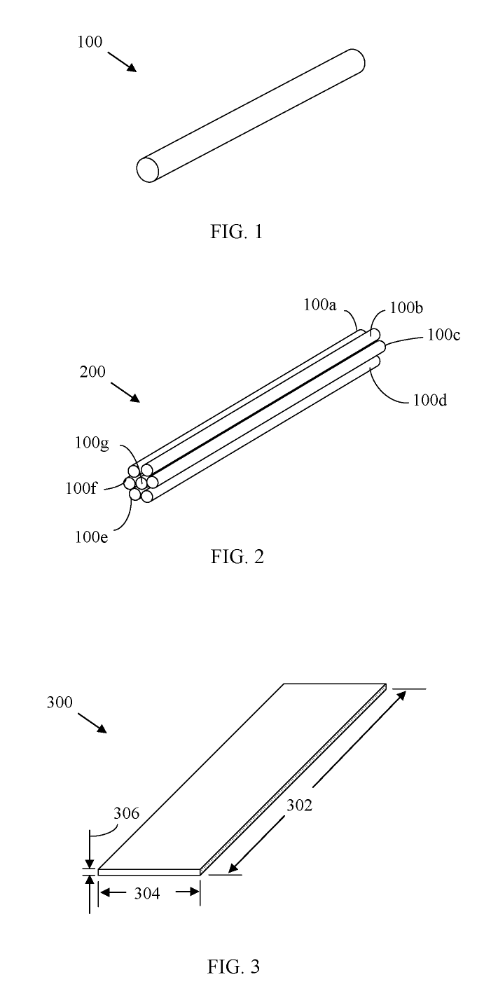

A variety of forms of material may be woven to form a layer of a panel. For example, FIG. 1 shows a fiber 100, according to an embodiment of the present invention. Fiber 100 may be made of a variety of materials. For example, fiber 100 may be a polymer, such as polyurethane, polyester, acrylic, phenolic, epoxy, an elastomer, polyolefins, polypropylene, polyethylene, vinyl ester, etc. In an embodiment, fiber 100 may be a monolithic/homogeneous material. In another embodiment, fiber 100 may include a first material (e.g., a polymer) that has one or more further materials therein, such as one or more nanomaterials. For example, fiber 100 may include nanomaterials such as nanowires, nanorods, nanotubes (e.g., carbon nanotubes), glass fibres, carbon fibres, nanoparticles (e.g., silver nanoparticles), nano silica, nano clay, nano aluminum, nano silver, nano carbon, black oxides, and/or other types of nanomaterials, as would be known to persons skilled in the relevant art(s). Fiber 100 may be formed in a variety of ways, including molding, extruding, or other ways of forming, as would be known to persons skilled in the relevant art(s). Nanomaterials may be added to the material forming fiber 100 at any appropriate point in the process of forming fiber 100, including when the material is in a liquid state, or as a coating (or partial coating) on fiber 100.

Multiple fibers 100 may be combined to form a woven fiber or “yarn.” For example, FIG. 2 shows a plurality of fibers 100a-100g that are tightly disposed in parallel to form a group 200 of fibers 100. Fibers 100a-100g of group 200 may be attached together by an adhesive, and/or may be twisted and/or woven (e.g., braided) together so that group 200 forms a strand of yarn or woven fiber. Forming group 200 provides additional mechanical strength when compared to an individual fiber 100.

FIG. 3 shows a ribbon 300, according to an embodiment of the present invention. As shown in FIG. 3, ribbon 300 is generally rectangular in shape, having a length 302, width 304, and thickness 306. Length 302, width 304, and thickness 306 can have values determined according to the requirements of the particular application. In one example, thickness 306 is in the range of 0.005-0.006 inches. Ribbon 300 generally has a ratio of width 304 to thickness 306 greater than 10 to 1, while having a length 302 typically much greater than width 304 (e.g., length 302 may be proportionally much longer relative to width 304 and thickness 306 than shown in FIG. 3). Ribbon 300 may be formed in a variety of ways, including a molding process, an extruding process, cutting ribbon 300 from a solid sheet, or by other process of forming, as would be known to persons skilled in the relevant art(s).

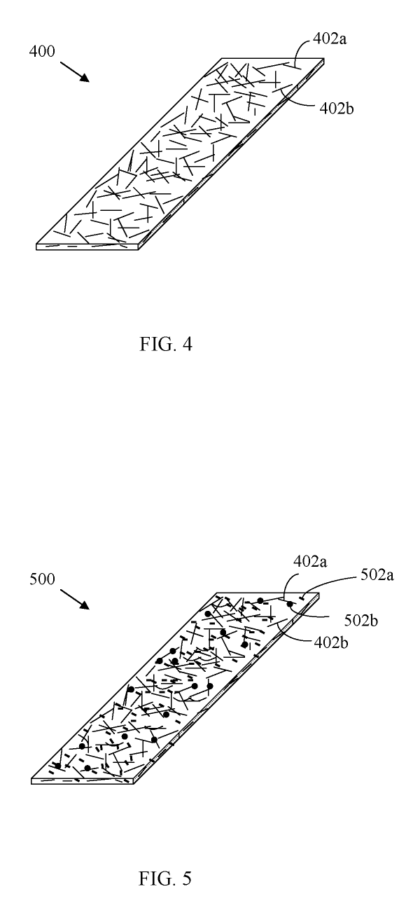

Ribbon 300 may be made of a variety of materials. For example, ribbon 300 may be a polymer, such as polyurethane, polyester, acrylic, phenolic, epoxy, an elastomer, polyolefins, polypropylene, polyethylene, vinyl ester, etc. In an embodiment, ribbon 300 may be a homogeneous material. In another embodiment, ribbon 300 may include a first material (e.g., a polymer) that has one or more further materials therein, such as one or more nanomaterials. For example, FIG. 4 shows a ribbon 400 that is generally similar to ribbon 300, with the addition of a plurality of nanotubes 402 interspersed within. Example nanotubes 402a and 402b are indicated in FIG. 4, for illustrative purposes. FIG. 5 shows a ribbon 500 that is generally similar to ribbon 400, with the addition of a plurality of nanoparticles 502 also interspersed within. Example nanoparticles 502a and 502b are indicated in FIG. 5, for illustrative purposes. Ribbons 400 and 500 may additionally or alternatively include other nanomaterials such as nanowires, nanorods, nanoclay, and/or other types of nanomaterials mentioned elsewhere herein or otherwise known. Nanomaterials may be added to the material forming ribbons 400 and 500 at any appropriate point in their forming process, including when the material is in a liquid state, or as a coating or partial coating.

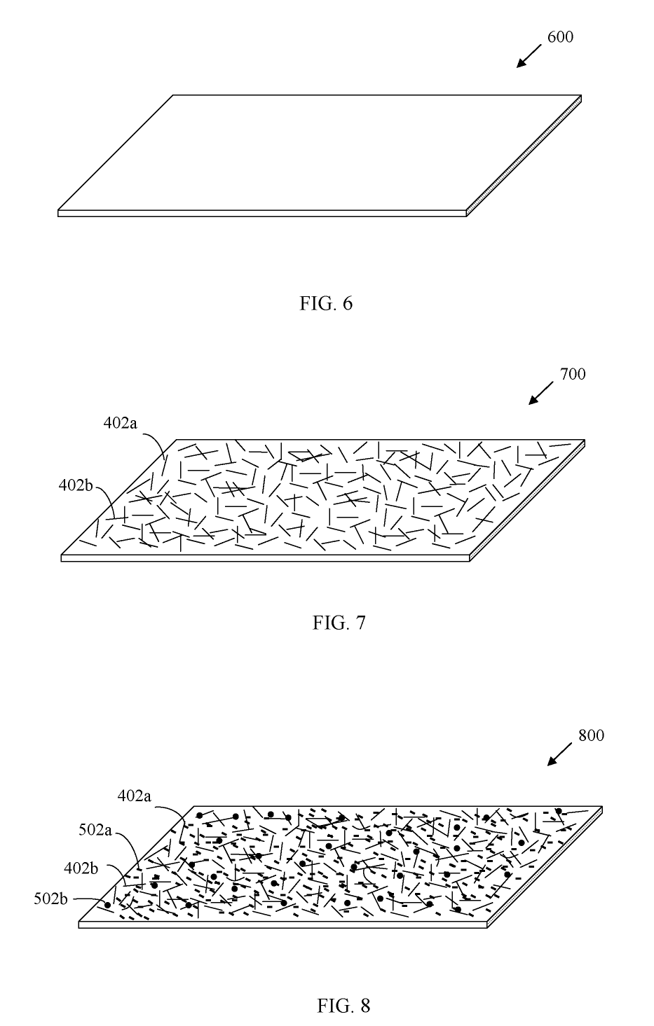

FIG. 6 shows a sheet or planar layer 600, according to another embodiment of the present invention. As shown in FIG. 6, planar layer 600 is generally rectangular in shape, where a length and width of planar layer 600 are generally of similar magnitude. Planar layer 600 may be formed in a variety of ways, including by a molding process, an extruding process, a process of where planar layer 600 is cut from a larger sheet, or by other process of forming, as would be known to persons skilled in the relevant art(s).

Planar layer 600 may be made of a variety of materials, such as a thin film, monolithic material. For example, planar layer 600 may be a polymer, such as polyurethane, polyester, acrylic, phenolic, epoxy, an elastomer, polyolefins, polypropylene, polyethylene, vinyl ester, etc. In an embodiment, planar layer 600 may be a homogeneous material (e.g., a polyurethane thin film). In another embodiment, planar layer 600 may include a first material (e.g., a polymer) that has one or more further materials therein, such as one or more nanomaterials. For example, FIG. 7 shows a sheet or planar layer 700 that is generally similar to planar layer 600, with the addition of a plurality of nanotubes 402 interspersed within. Example nanotubes 402a and 402b are indicated in FIG. 7, for illustrative purposes. FIG. 8 shows a planar layer 800 that is generally similar to planar layer 700, with the addition of a plurality of nanoparticles 502. Example nanoparticles 502a and 502b are indicated in FIG. 8, for illustrative purposes. Planar layers 700 and 800 may additionally or alternatively include other nanomaterials such as nanowires, nanorods, nanoclay, and/or other types of nanomaterials mentioned elsewhere herein or otherwise known. Nanomaterials may be added to the material forming planar layers 700 and 800 at any appropriate point in their forming process, including when the material is in a liquid state.

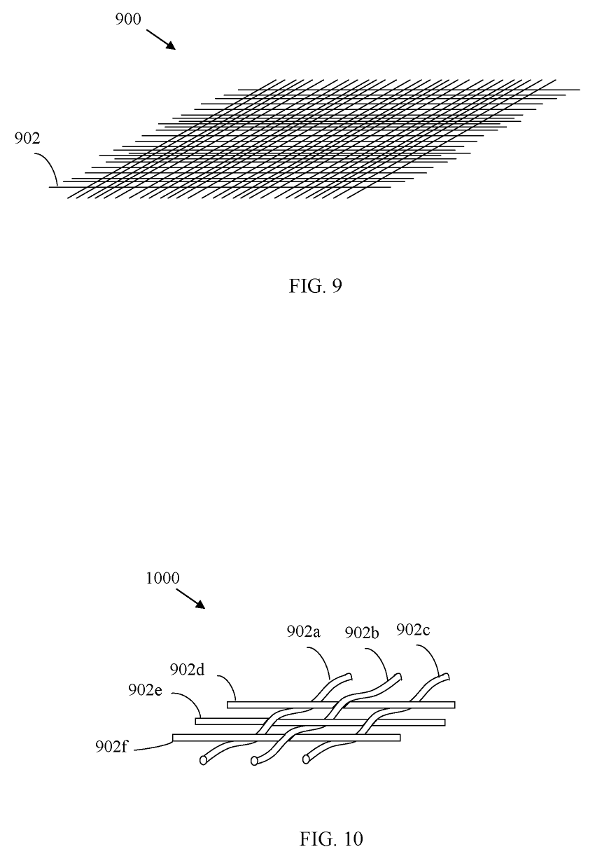

Various material configurations described above can be combined to form layers. For example, non-monolithic/non-homogeneous layers may be formed. Fibers, groups of fibers (e.g., yarn), and/or ribbons may be woven together to form layers. For example, FIG. 9 shows a woven layer 900, according to an example embodiment of the present invention. FIG. 10 shows a close up view of a portion 1000 of woven layer 900. In the example of FIG. 10, woven layer 900 is shown formed of a woven pattern of fibers 902, for illustrative purpose. Alternatively, woven layer 900 may be formed of a woven pattern of yarn (e.g., fiber group 200) or a woven pattern of ribbons (e.g., one or more of ribbons 300, 400, 500). As shown in FIG. 10, fibers 902a-902c, which extend in a first direction, are woven with fibers 902d-902f, which extend in a second direction. Fibers 902a-902c and 902d-902f may have any relative alignment in a layer, including being aligned 90 degrees, 45 degrees, or other angle relative to each other. Layers that include a mesh may also include further orientations of fibers, random or otherwise, which may have different lengths relative to each other (e.g., substantially continuous, chopped, etc.). An example of such a layer is a fiberglass matte. Any type of weave can be used to form layers. For example, a plain weave pattern, a twill weave pattern, or other type of weave pattern may be used.

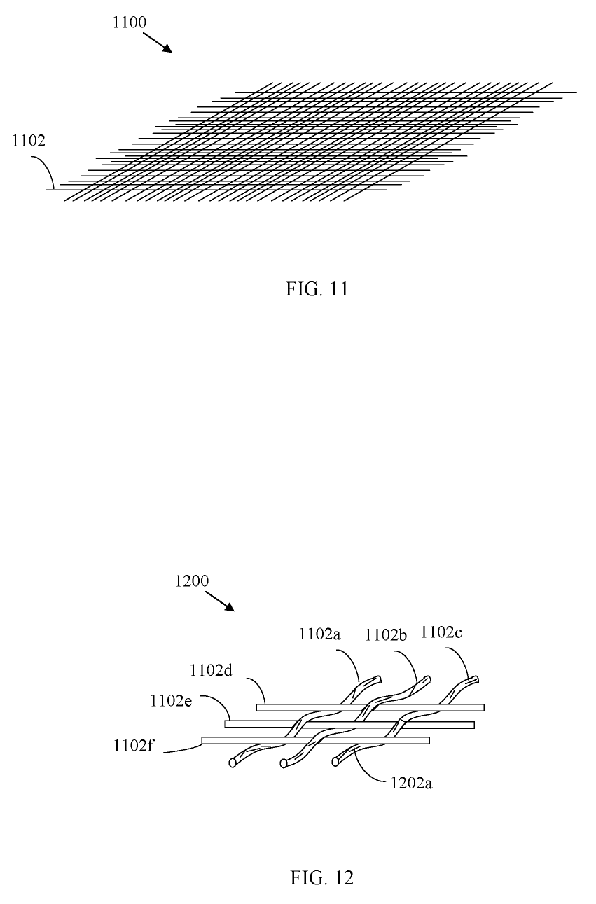

Fibers 902, or other materials used to create a woven layer (e.g., yarns, ribbons), may be any type described herein, including homogeneous fibers/yarn/ribbon and/or heterogeneous fibers/yarn/ribbon. Thus, in an embodiment, all fibers 902 of woven layer 900 may be the same. Alternatively, different types of fibers/yarn/ribbons may be present in woven layer 900, including fibers/yarn/ribbons that include and do not include nanomaterials. For example, FIG. 11 shows a woven layer 1100 that includes fibers 1102. Some of fibers 1102 include nanomaterials, according to an embodiment of the present invention. FIG. 12 shows a close up view of a portion 1200 of woven layer 1100. As shown in FIG. 12, fibers 1102a-1102c extend in a first direction and include nanotubes 1202. Fibers 1102a-1102c are woven with fibers 1102d-1102f, which extend in a second direction. Fibers 1102d-1102f do not include nanotubes 1202. Thus, portion 1200 of woven layer 1100 includes a first set of fibers that do not include nanomaterials that are woven with a second set of fibers that do include nanomaterials. In an alternative embodiment, all of fibers 1102a-1102f may include nanomaterials. In embodiments, all of fibers 1102a-1102f may include the same or different nanomaterial configurations. For example, fibers 1102 may additionally or alternatively include nanomaterials such as nanowires, nanorods, nanoparticles, nanoclay, and/or other types of nanomaterials mentioned elsewhere herein or as would be known to persons skilled in the relevant art(s).

In an alternative embodiment, layers may include fibers or rods arranged in a single substantially uniform direction (e.g., being parallel/unidirectional). The fibers/rods may alternatively be oriented in a plurality of directions to accommodate loadings to panel 100 from multiple directions. The fibers may be individual fibers or woven fibers. In embodiments, the rods may be solid or hollow. Example embodiments for layers that include rods are described in further detail below. In a still further embodiment, layers may include fibers and/or rods having random orientations.

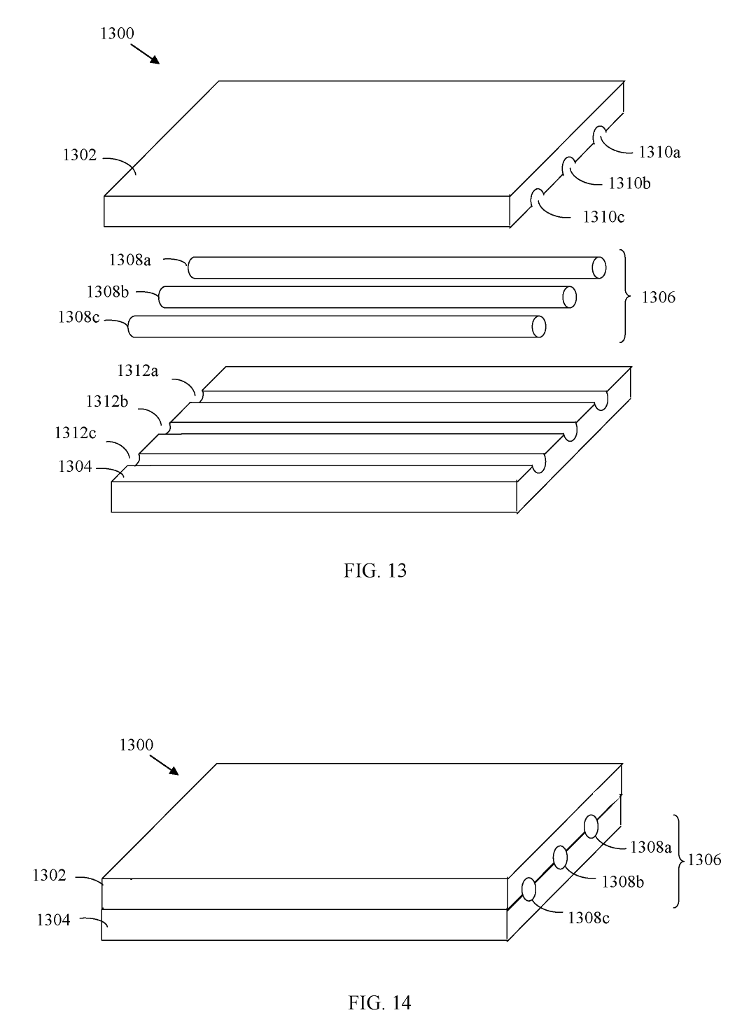

In embodiments, one or more layers of a panel may include rods that provide structural reinforcement to the panel. FIG. 13 shows a perspective exploded view of a layer 1300 that includes rods, according to an example embodiment of the present invention. FIG. 14 shows a perspective side view of layer 1300, in non-exploded form. Layer 1300 is formed of sub-layers, and layer 1300 may alternatively be considered to be a panel. As shown in FIGS. 13 and 14, layer 1300 includes a first layer 1302, a second layer 1304, and a third layer 1306. First and second layers 1302 may each be any layer type described elsewhere herein, including a layer of a homogeneous material, a layer of material that includes micro- and/or nanomaterials, a layer that includes fibers, ribbons, and/or woven materials, a form layer, etc. Third layer 1306 is a layer of rods 1308, and may also be referred to as a “rod layer.” Any number of rods 1308 may be present in layer 1306. For instance, in the example of FIGS. 13 and 14, third layer 1306 includes first-third rods 1308a-1308c. Rods 1308 have a generally cylindrical shape, having a circular cross-section, although rods 1308 may have other shapes, including having rectangular cross-sections. Furthermore, rods 1308 may have any length, as desired for a particular application. Third layer 1306 is positioned between first and second layers 1302 and 1304 to form layer 1300 as a stack of layers.

Rods 1308 can be made of any suitable material, including any polymer mentioned elsewhere herein or otherwise known, a metal (e.g., aluminum, titanium, etc.) or combination of metals/alloy (e.g., steel), a ceramic material, a composite material, fiberglass infused polyester tubes, etc. Rods 1308 can be made of layer materials described elsewhere herein, including having fibers, weaves, nanomaterials, and/or functional elements included therein. In the example of FIGS. 13 and 14, rods 1308a-1308c are shown having a substantially parallel/unidirectional arrangement. However, in alternative embodiments, rods 1308 in third layer 1306 may have other arrangements, including a non-parallel arrangement (e.g., including a random arrangement). Rods 1308 can have any suitable size, including having diameters in the order of an inch, having nano-scale diameters, or having diameters greater than or between these ranges.

Rods 1308 can be solid (e.g., as shown in FIGS. 13 and 14) or can be hollow (e.g., can be tubes). For example, rods 1308a-1308c may be fiberglass infused polyester tubes having a 0.25 inch inner diameter and a 0.5 inch outer diameter. Persons skilled in the relevant arts would be able to implement tubes having various sizes, including various cross-sectional dimensions, various materials, and various orientations and positions within a stack.

A panel that includes rods 1308 may be manufactured in a variety of ways. For instance, as shown in FIGS. 13 and 14, first and second layers 1302 and 1304 may be formed separately from each other. As shown in FIG. 13, a first set of cylindrical recesses 1310 (e.g., recesses 1310a-1310c) may be formed in a surface of first layer 1302, and a second set of cylindrical recesses 1312 (e.g., recesses 1312a-1312c) may be formed in a surface of second layer 1304. Recesses 1310 and 1312 may be formed in any manner, such as by a molding process (e.g., by molds used to form layers 1302 and 1304), by machining recesses 1310 and 1312 into layers 1302 and 1304, by impressing recesses 1310 and 1312 into layers 1302 and 1304 (e.g., by heating layers 1302 and 1304 and subsequently applying pressure), etc. To form layer 1300, rods 1308 may be positioned between layers 1302 and 1304, and layers 1302 and 1304 may be moved into contact with each other, with rods 1308 fitting into recesses 1310 and 1312.

In another embodiment, recesses 1310 and 1312 may not be pre-formed in first and second layers 1302 and 1304. To form layer 1300, rods 1308 may be positioned between layers 1302 and 1304, and layers 1302 and 1304 may be moved into contact with each other. By compressing layers 1302 and 1304 together, rods 1308 may form recesses 1310 and 1312 in layers 1302 and 1304, respectively.

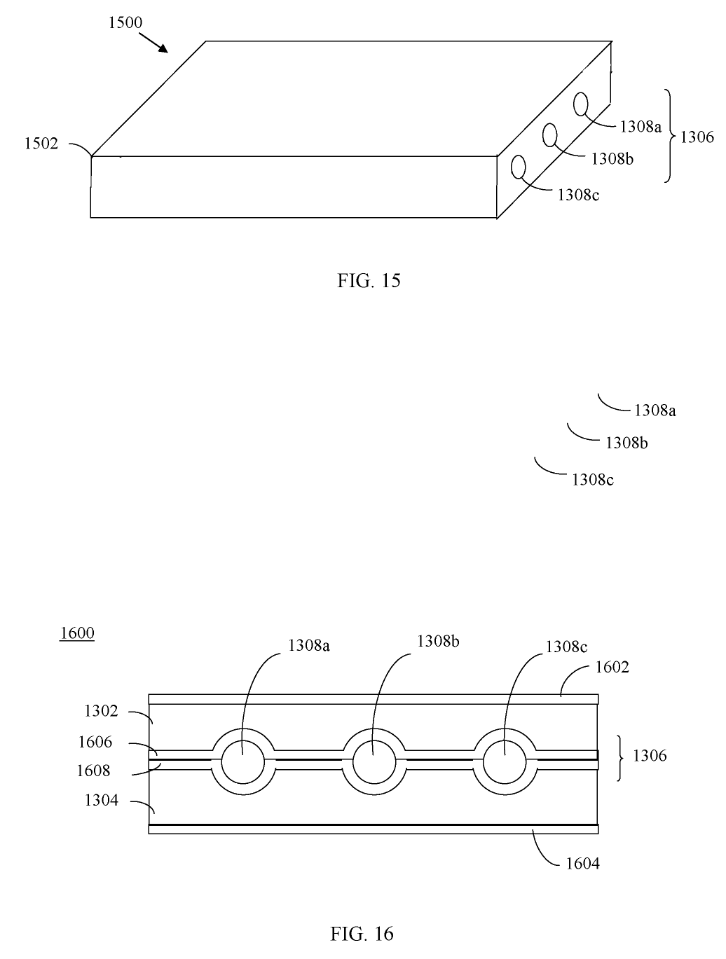

In another embodiment, layers 1302 and 1304 may instead be formed as a single layer in which rods 1308 are positioned. FIG. 15 shows an example of a layer 1500 which is formed of a single layer 1502 of material that encapsulates rods 1308 (e.g., rods 1308a-1308c). For instance, layer 1502 may be formed in any manner described elsewhere herein or otherwise known, and holes may be drilled through layer 1502 in which rods 1308 may be inserted. Alternatively, rods 1308 may be positioned in a mold, and a material may be inserted into the mold to form layer 1502 around rods 1308. Layers 1300 and 1500 may be formed in alternative ways, as would be known to persons skilled in the relevant art(s).

Referring back to FIGS. 13 and 14, layers 1302, 1304, and 1306 may be attached together in any manner, including in other ways for attaching layers described elsewhere herein. For instance, FIG. 16 shows a cross-sectional view of a layer 1600, formed according to an example embodiment of the present invention. Layer 1600 is an example of layer 1300 shown in FIGS. 13 and 14. As shown in FIG. 16, layer 1600 includes first, second, and third layers 1302, 1304, and 1306. Furthermore, layer 1600 includes a first coating layer 1602, a second coating layer 1604, a first adhesive layer 1606, and a second adhesive layer 1608. First coating layer 1602 is positioned on a first surface of first layer 1302 that is opposite a second surface of first layer 1302 that is adjacent to third layer 1306. Second coating layer 1604 is positioned on a first surface of second layer 1304 that is opposite a second surface of second layer 1304 that is adjacent to third layer 1306. First and second coating layers 1602 and 1604 may each be any type of coating layer described elsewhere herein, including a layer of material (e.g., a polymer) that includes nanomaterials, a metal, etc. First and second coating layers 1602 and 1604 may be applied to first and second layers 1302 and 1304, respectively, in any manner described herein, including by laminating, molding, spraying (e.g., electrostatic spraying, which can be used to coat a layer with an electrically conductive or electrically non-conductive material), rolling on, etc.

First and second adhesive layers 1606 and 1608 bond together first, second, and third layers 1302, 1304, and 1306. First adhesive layer 1606 may be applied to the second surface of first layer 1302, and second adhesive layer 1608 may be applied to the second surface of second layer 1304. First and second adhesive layers 1606 may each be any type of adhesive material described elsewhere herein, including a resin, a foam layer, a glue, an epoxy, etc., and may optionally include micro- and/or nanomaterials. First and second coating layers 1602 and 1604 may be applied to first and second layers 1302 and 1304, respectively, in any manner described herein, including by laminating, molding, spraying, rolling on, etc. When first and second layers 1302 and 1304 are moved into contact with each other (e.g., by a compression mechanism), first and second adhesive layers 1606 and 1608 come into contact with each other and bond together first, second, and third layers 1302, 1304, and 1306. Furthermore, first and second adhesive layers 1606 and 1608 may combine to form a single layer in layer 1600.

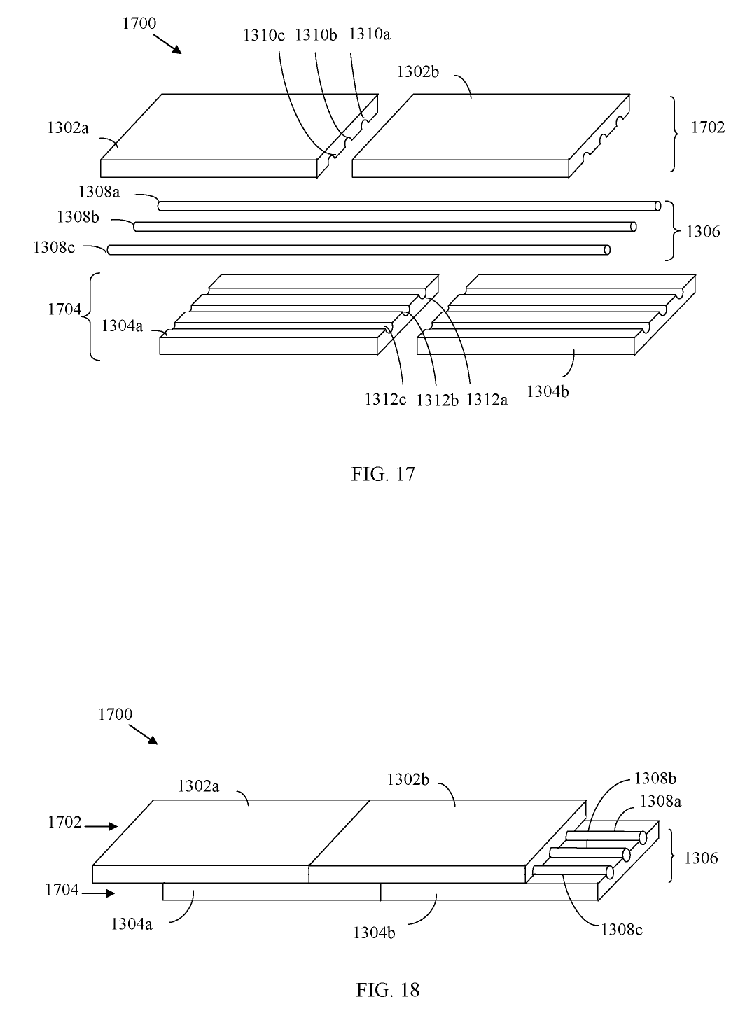

Rods 1308 provide additional strength to layers 1300, 1500, and 1600, including strength in tension, compression, and/or torsion with respect to layers 1300, 1500, and 1600. Rods 1308 may be textured (e.g., provided with grooves, ridges, etc.) to enhance adhesion with layers 1302, 1304, and/or 1502. Layers 1300, 1500, and 1600, may be combined in any manner to form larger layers/panels. For example, FIG. 17 shows a perspective exploded view of a layer 1700, according to an embodiment of the present invention. FIG. 18 shows a perspective side view of layer 1700, in non-exploded form. As shown in FIGS. 17 and 18, layer 1300 includes a first layer 1702, a second layer 1704, and third layer 1306. First layer 1702 includes a plurality of first layers 1302. Second layer 1704 includes a plurality of second layers 1304. For example, in the embodiment of FIGS. 17 and 18, first layer 1702 includes layers 1302a and 1302b, and second layer includes layers 1304a and 1304b. In further embodiments, first and second layers 1702 and 1704 may include further numbers of layers 1302 and 1304, respectively, to generate layer 1700 to have any desired length and/or width.

As shown in FIG. 17, layers 1302a and 1302b are positioned in series to form first layer 1702, such that recesses 1310 in layers 1302a and 1302b are aligned with each other. Furthermore, layers 1304a and 1304b are positioned in series to form second layer 1704, such that recesses 1312 in layers 1304a and 1304b are aligned with each other. To form layer 1700, rods 1308 (e.g., rods 1308a-1308c) of third layer 1306 are positioned between layers 1702 and 1704, and layers 1702 and 1704 are moved into contact with each other, with rods 1308 fitting into recesses 1310 and 1312 in layers 1302a and 1302b and layers 1304a and 1304b, respectively.

Note that in embodiments, layers 1302 in first layer 1702 may be aligned in any manner relative to layers 1304 in second layer 1704. For example, as shown in FIGS. 17 and 18, layers 1302 in first layer 1702 may be staggered relative to layers 1304 in second layer 1704. For instance, when layer 1700 is formed, layer 1302b of first layer 1702 may have a first portion in contact/overlapping with layer 1304a and a second portion in contact/overlapping with layer 1304b of layer 1704, as shown in FIG. 18. Furthermore, layer 1304a of second layer 1704 may have a first portion in contact/overlapping with layer 1302a and a second portion in contact/overlapping with layer 1302b of layer 1702, as shown in FIG. 18. Such a staggered arrangement of layers 1302 and 1304 may enable greater adhesion and strength in layer 1700. In an alternative embodiment, each layer 1302 in first layer 1702 may be aligned with a corresponding layer 1304 in second layer 1704, in a non-staggered arrangement. Furthermore, note that in embodiments, layers 1302 in first layer 1702 may have different lengths from layers 1304 in second layer 1704. Furthermore, in embodiments, layers 1302 in first layer 1702 may have different lengths from each other, and layers 1304 in second layer 1704 may have different lengths from each other.

Example Panel Embodiments

As described above, multiple layers, such as those described above, may be modularly combined to form composite panels, according to embodiments of the present invention. For example, layers may be stacked to form a panel. Layers of any type may be stacked in any order to form panels. For example, one or more homogeneous layers may be stacked with one or more heterogeneous layers. Furthermore, one or more woven layers may be stacked with one or more non-woven layers. One or more rod layers may be stacked with one or more non-rod layers. The distribution of homogeneous and/or heterogeneous layers in a panel may be selected based on the characteristics desired for the particular panel application.

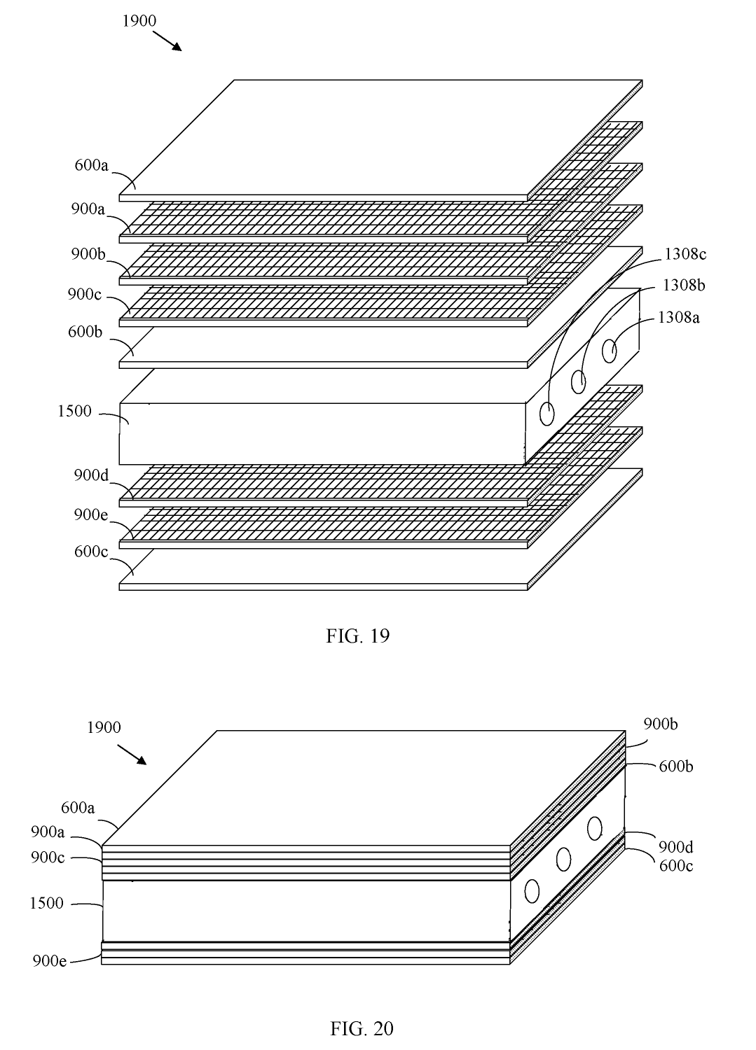

For instance, FIG. 19 shows a perspective exploded view of a panel 1900, according to an embodiment of the present invention. FIG. 20 shows a side view of panel 1900, in non-exploded form. As shown in FIGS. 19 and 20, panel 1900 includes a first layer 600a, a second layer 900a, a third layer 900b, a fourth layer 900c, a fifth layer 600b, a sixth layer 1500, a seventh layer 900d, an eighth layer 900e, and a ninth layer 600c. In FIG. 20, first layer 600a is attached to second layer 900a, second layer 900a is attached to third layer 900b, third layer 900b is attached to fourth layer 900c, fourth layer 900c is attached to fifth layer 600b, fifth layer 600b is attached to sixth layer 1500, sixth layer 1500 is attached to seventh layer 900d, seventh layer 900d is attached to eighth layer 900e, and eighth layer 900e is attached to ninth layer 600c, to form panel 1900 as a stack of layers. Although not shown in FIGS. 19 and 20, an adhesive material may be present between adjacent layers of panel 1900 to attach the adjacent layers together in the stack.

As shown in FIG. 19, second, third, fourth, seventh, and eighth layers 900a-900e are woven layers similar to woven layer 900 shown in FIG. 9. For example, in an embodiment, each of layers 900a-900e is a weave of polypropylene ribbons, and each of layers 900a-900e has a thickness in the range of 0.005-0.006 inches (e.g., 0.132 mm) and a weight of approximately 0.02 lbs/sq-ft (0.11 Kg/sq-meter). Polypropylene may be formed into ribbons (each similar to ribbon 300, for instance) using an extrusion process, and the ribbons may be weaved together to form the fabric of each of layers 900a-900e. In an embodiment, nanomaterials (e.g., multi-walled carbon nanotubes) may be introduced into the polymer (e.g., polypropylene) resin before performing the extrusion.

First, fifth, and ninth layers 600a-600c are homogeneous planar layers similar to planar layer 600 shown in FIG. 6. For example, in an embodiment, each of layers 600a-600c is a polyurethane (PU) thin film, having a thickness in the range of 0.010-0.015 inches.

Sixth layer 1500 is a rod layer as also shown in FIG. 15. Sixth layer 1500 may be configured to provide additional strength and rigidity to panel 1900. For example, in an embodiment, rods 1308a-1308c may be steel rods having a 0.5 inch outer diameter, and sixth layer 1500 may be an inch thick.

The example number of layers and types of layers shown in FIGS. 19 and 20 for panel 1900 are provided for purposes of illustration, and are not intended to be limiting. In embodiments, any number and types of layers may be included in a panel, as desired for a particular application. The ratio of woven layers (e.g., layers 900a-900e) to non-woven layers (e.g., layers 600a-600c and 1500) can have any value. For example, in an embodiment, the ratio can be 1:1. In another embodiment, the ratio of woven layers to non-woven layers is greater than 1:1 (e.g., 2:1). For example, multiple woven layers may be stacked on each other, followed by one non-woven layer, followed by multiple additional woven layers, followed by another non-woven layer, etc, until a desired number of layers is placed in the stack. Furthermore, any number of rod layers (e.g., layer 1300 of FIG. 13, layer 1500 of FIG. 15, layer 1600 of FIG. 16, and/or layer 1700 of FIG. 17) may be included in a stack with other types of layers.

Layers 600a-600c, 900a-900e, and 1500 may be attached to each other in panel 1900 in a variety of ways. For example, an adhesive material, such as a glue, a resin, a foam material, a thin film adhesive, etc., may be applied to surfaces of layers to attach adjacent layers together. The adhesive material may be applied in any form, including as a gel, liquid, or solid, an in any manner, including by pouring, flowing, spraying, rolling on, etc. In another example, pressure thermoforming techniques, such as autoclave or a compression molding process, may be used to compress/heat layers into panel 1900. In one example, thin sheets of thermoplastic adhesive may be interspersed between layers of a stack. The thin sheets of thermoplastic adhesive themselves may be homogeneous materials or heterogeneous materials (e.g., have one or more nanomaterials included therein). The stack is heated, thereby activating the thermoplastic adhesive to adhere the layers of the stack together. In another embodiment, a foam layer, as described above, may be formed between two other layers. The foam layer may operate as an adhesive material to attach together the two layers (in addition to providing any further features that may be provided by the foam layer).

Note that in a further embodiment, panel 1900 may include one or more layers of further materials. For example, panel 1900 may include one or more layers of fabric made from another synthetic fiber such as Kevlar, additional types of nanoparticles, etc., that are interspersed throughout panel 1900. In another embodiment, panel 1900 may include one or more layers of recyclable materials. For example, the properties of an extruded polypropylene (or other material) ribbon may be enhanced by recycling and then re-extruding the polypropylene into ribbon form a second time or even further times.

Each layer may be selected/tuned to a degree of precision based on the requirements of a particular application, such as impact resistance, stiffness, melt-point, flammability, chemical resistance, electrical conductivity, aerial density, sensing abilities, and/or other requirements. Such tuning can be performed in a number of ways. For example, tuning can be performed by selecting the material for the layer, selecting dimensions of the layer (e.g., thickness, length, width), selecting whether the layer is woven or non-woven, if the layer is woven, selecting whether fibers, matte, yarn, and/or ribbon is woven to form the layer, selecting whether to add nanomaterials to the layer, selecting the type of and concentration of nanomaterials added to the layer (if added), and/or by performing other selection criteria described elsewhere herein or otherwise known. For example, one or more layers of a panel may be made electrically conductive by incorporating nanomaterials (e.g., metallic or non-metallic) into the one or more layers.

In an embodiment, a panel may be manufactured to be any weight, including lightweight, medium weight, or heavyweight, depending on factors such as materials used in layers of the panel, thicknesses of the layers, a number of layers, etc. A panel may be manufactured of any thickness, including thick, medium thickness, and/or thin. For example, in one embodiment, a panel can be 0.5 pounds per square foot at ¼″ thick. In an embodiment, a panel may be stiff or flexible.

Embodiments enable a modularly-constructed panel/system, constructed from modular/interchangeable components. A panel may be considered to be a system of building blocks, fully integrated to create a self-contained system. Panels may be modularly combined as building blocks to create a variety of form factors. Furthermore, panels may be manufactured that are fully integrated and self-contained. In embodiments, a panel may be coated with one or more of a variety of types of coatings such as polymers, paints, ceramics, metals, etc. For example, in an embodiment, a coating may be a skin gel coat, which may be clear or opaque, and may be applied in any manner, such as by spraying, painting, depositing, etc.

Example Assembly Embodiments for Panels

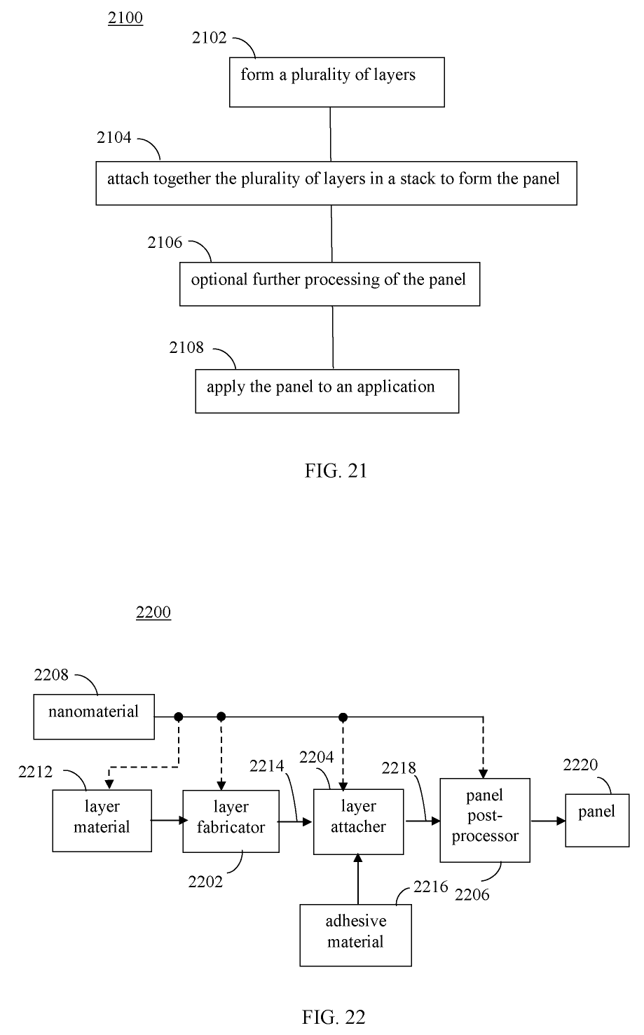

Panels may be assembled in a variety of ways, according to embodiments. For instance, FIG. 21 shows a flowchart 2100 for fabricating a panel, according to an example embodiment of the present invention. Flowchart 2100 may be performed by a variety of assembly systems, which may incorporate any suitable manual, mechanical, electrical, chemical, and/or other fabrication techniques. For example, FIG. 22 shows a panel fabrication system 2200, according to an embodiment of the present invention. For illustrative purposes, flowchart 2100 is described with respect to panel fabrication system 2200 shown in FIG. 22. As shown in FIG. 22, system 2200 includes a layer fabricator 2202, a layer attacher 2204, and a panel post-processor 2206. Further structural and operational embodiments will be apparent to persons skilled in the relevant art(s) based on the discussion regarding flowchart 2100. Flowchart 2100 is described as follows.

Flowchart 2100 begins with step 2102. In step 2102, a plurality of layers is formed. For instance, referring to FIG. 22, layer fabricator 2202 may perform step 2102. Layer fabricator 2202 is configured to form one or more layers that may be combined to form a panel. As shown in FIG. 22, layer fabricator 2202 receives layer material 2212. Layer material 2212 may include one or more materials used to form layers of a panel. For example, layer material 2212 may include one or more polymers, such as polyurethane, polyester, acrylic, phenolic, epoxy, an elastomer, polyolefins, polypropylene, polyethylene, and/or vinyl ester, a ceramic material, a metal, and/or other layer materials.

Layer fabricator 2202 may be configured to form any type of layer described herein. For example, layer fabricator 2202 may be configured to receive or to form fibers (e.g., fiber 100 of FIG. 1), groups of fibers (e.g., group 200 of FIG. 2), ribbons (e.g., ribbons 300, 400, and 500 shown in FIGS. 3-5), layers (e.g., layer 600, 700, and 800 shown in FIGS. 6-8), and woven materials (e.g., woven layers 1100 and 1300 shown in FIGS. 11 and 13), and/or rod layers (e.g., layers 1300, 1500, 1600, and 1700 shown in FIGS. 13-18). Layer fabricator 2202 may include one or more extruders (e.g., to form fibers and ribbons), one or more molds (e.g., to form fibers, ribbons, layers etc.), a cutting apparatus (e.g., a saw, etc.) to cut ribbons and/or layers from sheets of material, a weaving apparatus to weave fibers and/or ribbons, and/or further layer forming systems and apparatuses and layer material processing systems and apparatuses.

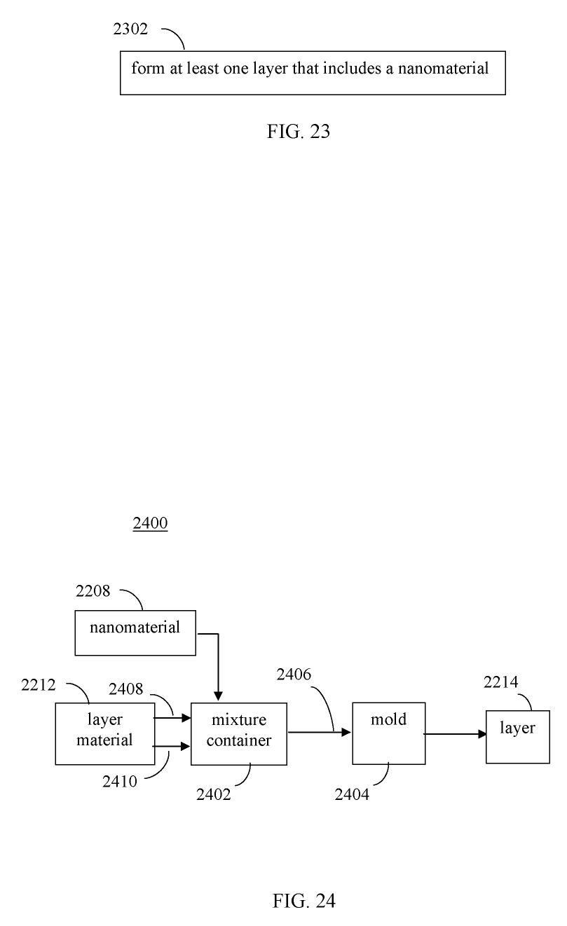

In an embodiment, step 2102 of flowchart 2100 may include step 2302 shown in FIG. 23. In step 2302, at least one layer is formed that includes a nanomaterial. For instance, as shown in FIG. 22, layer fabricator 2202 may optionally receive nanomaterial 2208, and may incorporate nanomaterial 2208 in one or more layers. Nanomaterial 2208 may include one or more of the nanomaterials described elsewhere herein, including nanowires, nanorods, nanotubes (e.g., carbon nanotubes), glass fibres, carbon fibres, nanoparticles (e.g., silver nanoparticles), nano silica, nano clay, nano aluminum, nano silver, nano carbon, black oxides, graphene, nano platelets, organic and inorganic nano elements, etc. It is noted that persons skilled in the relevant art(s) would be capable of selecting from a wide variety of nanomaterials, whether or not such materials include the “nano” prefix. The particular nanomaterials included in a layer may be selected based on a particular application for the layer/panel, as would be known to persons skilled in the relevant art(s) from the teachings herein. For example, silver nanoparticles may be included in a layer for bacteria resistance in a medical application. It is also recognized that the nanomaterials may be treated in such as way as to provide additional functionality. Such additional functionality may be stand alone (e.g., nano chemical sensors) or the nanomaterials may interact with other components in a panel to enable a desired functionality (e.g., as in the case of reinforcing fibers, electrical conductivity, or thermal conductivity).

In an embodiment where nanomaterial 2208 is received by layer fabricator 2202, nanomaterial 2208 may be incorporated into a material of layer material 2212 by layer fabricator 2202 in any manner described elsewhere herein or otherwise known. For example, in an embodiment, nanomaterial 2208 may be added to a foam material to be incorporated into a layer.

For instance, FIG. 24 shows a block diagram of a layer fabricator 2400, according to an example embodiment of the present invention. Layer fabricator 2400 is an example of layer fabricator 2202 of FIG. 22. As shown in FIG. 24, layer fabricator 2400 includes a mixture container 2402 and a mold 2404. Mixture container 2402 is a container that receives a first material 2408 of layer material 2212, such as a resin or other layer material. Nanomaterial 2208 may optionally be added to mixture container 2402. Mixture container 2402 is configured to mix the combination of first material 2408 and nanomaterial 2208. Mixture container 2402 may be configured to perform the mixing in any manner, including by paddle mixing, ultrasonic mixing, milling, shear mixing, agitation, boiling, and/or any other suitable mixing technique, which may be selected based on the particular application. A second material 2410 of layer material 2212 may optionally be received by mixture container 2402. Second material 2410 may be a second resin or other layer material to function as a catalyst to a foaming and/or curing process. Second material 2410 may be mixed with first material 2408 and nanomaterial 2208 in mixture container 2402 as described above. Note that the order in which these materials/elements are mixed may be modified/selected to enable particular desired properties in the resulting layer(s).

As shown in FIG. 24, mixture container 2402 outputs a mixed layer material 2406, which is received by mold 2404. Mold 2404 includes an enclosure having a predefined shape that is a desired shape for a layer to be formed by layer fabricator 2400. Further layer materials may be optionally input to mold 2404, including one or more rods (e.g., rods 1308 shown in FIG. 17), fibers (e.g., fiber 100 shown in FIG. 1 or group 200 shown in FIG. 2), ribbons (e.g., ribbons 300, 400, and/or 500 shown in FIGS. 3-5), woven materials (e.g., woven layers 900 and/or 1100 shown in FIGS. 9 and 11), and/or other layer materials described elsewhere herein. The foaming process proceeds in mold 2404, such that mixed layer material 2406 is allowed to foam/expand to fill mold 2404, and to cure/harden into the predetermined shape of the enclosure of mold 2404. If rods, fibers, ribbons, woven materials, and/or further layer materials are present in mold 2404, the foam spreads and hardens around the rods, fibers, ribbons, woven materials, and/or further layer materials. As described above, second material 2410 may cause mixed layer material 2406 to foam. Alternatively, second material 2410 may not be added to mixture container 2402, and mold 2404 may apply heat, pressure, water vapor, or other foaming/curing agent to mixed layer material 2406 to induce the foaming. As shown in FIG. 24, mold 2404 outputs layer 2214, which is formed of the cured material of mixed layer material 2406. Layer 2214 has a shape based on the enclosure of mold 2404.

Note that the example of FIG. 24 is provided for purposes of illustration. Layer fabricator 2202 shown in FIG. 22 may be configured to form layers using a mold (as shown in FIG. 24), such as an injection molding process or a compression molding process, and/or according to other techniques, including an extrusion process, a roll process, a casting process, and/or any other technique used to process polymers and/or other materials into shapes and configurations.

In step 2104, the plurality of layers is attached together in a stack to form the panel. For instance, referring to FIG. 22, layer attacher 2204 may perform step 2104. Layer attacher 2204 receives a plurality of layers 2214 from layer fabricator 2202. Furthermore, layer attacher 2204 may optionally receive nanomaterial 2208. Layer attacher 2204 is configured to stack the received plurality of layers 2214 in a predetermined order, and to attach together the plurality of layers 2214 in the stack to form a panel 2218. In an embodiment, layer attacher 2204 may receive an adhesive material 2216. Adhesive material 2216 may be any adhesive material mentioned elsewhere herein or otherwise known, including an epoxy, laminate, a glue, a foam material, a thin film adhesive, and/or other adhesive material. Layer attacher 2204 may be configured to apply adhesive material 2216 to one or more layers and/or between one or more adjacent pairs of layers in the stack. Layer attacher 2204 may apply a compressive force, heat, and/or other curing agent/technique to the stack to cause adhesive material 2216 to cure so that the plurality of layers 2214 to become attached together to form panel 2218.

Note that in embodiments, a formed panel (e.g., layer 1300 of FIG. 14, layer 1500 of FIG. 15, layer 1600 of FIG. 16, layer 1700 of FIG. 18, or panel 1900 shown in FIG. 20) may be received by layer attacher 2204 to be stacked and attached to one or more other formed panels and/or layers.

In step 2106, the panel is optionally further processed. For instance, referring to FIG. 22, panel post-processor 2206 may perform step 2106. Panel post-processor 2206 receives panel 2218, and may optionally perform post-processing on panel 2218. For example, panel post-processor 2206 may apply a coating (e.g., as described elsewhere herein) to panel 2218, may shape panel 2218 (e.g., as described elsewhere herein), and/or may otherwise post-process panel 2218. As shown in FIG. 22, panel post-processor 2206 may optionally receive nanomaterial 2208. Nanomaterial 2208 may be applied to panel 2218 in a coating, for example.

As shown in FIG. 22, panel post-processor 2206 generates panel 2220. In embodiments, panel 2220 may have any configuration of layers described elsewhere herein (e.g., any of layers 1300, 1500, 1600, or 1700 or panel 1900) or any other number and combination of layers described herein.

In step 2108, the panel is applied to an application. In embodiments, panel 2220 generated by system 2200 may be configured, delivered, and/or applied to be used in any suitable application described elsewhere herein or otherwise known to persons skilled in the relevant art(s) from the teachings herein.

Example Panel Applications

The layer embodiments of FIGS. 1-18, panel embodiments of FIGS. 19 and 20, fabrication processes of FIGS. 21 and 23, and fabrication systems of FIGS. 22 and 24 are provided for illustrative purposes, and are not intended to be limiting. Layers of panels, such as panels 1900, 2218, and 2220 may be manufactured/assembled as desired for a particular application. Any number of layers, layer types, layer sizes (e.g., lengths, widths, and thicknesses), and embedded materials/components may be used in a particular panel. A panel may be fabricated having any desired hardness, strength, and durability, as desired by combining the appropriate layer materials and/or nanomaterials, For instance, one or more foam layers may be provided that include nanomaterials to provide characteristics desired for a particular panel. One or more woven layers may be provided that provide strength and flexibility for a particular panel. One or more bar layers may be provided that provide greater strength and rigidity for a particular panel. One or more coating layers may be provided that provide environmental protection for a particular panel. These layer types, and further layer types, may be provided to provide any characteristics described elsewhere herein.

For example, the one or more protective layers may be made from a harder and/or more durable material (e.g., a dense polymer, a metal, etc.) and/or may incorporate nanomaterials and/or other particles (e.g., metal particles) that increase a durability and/or hardness of the one or more layers. The one or more protective layers may provide protection against weather (e.g., rain, sleet, snow, extreme cold, extreme heat), against impacts (e.g., from vehicles, from projectiles such as bullets, etc.), against explosions, and/or against further external threats and/or internal threats or sources of damage. For example, a panel may form a container, or may be formed around the outer surface of a container, that is configured to contain an explosive material. The panel may be configured to damp the explosive force of the container if the explosive material inside the container explodes.

In an embodiment, a panel may be incorporated into a structure such as an automobile, a truck such as a delivery truck, a shipping container, an aircraft skin, wearable armor or accessories (including camouflaged armor), wind turbine blades, doors, walls, floors, roofs, and into further structures, including enclosures. Such structures may be newly built with panels embodiments, and/or existing structures may be retrofitted with panel embodiments. In an embodiment, a panel may be attached to a structure. For example, one or more panels may be attached (e.g., by an adhesive mechanism, such as an adhesive material, one or more nails, screws, bolts, etc.) to an outer surface of an automobile, truck, shipping container, aircraft, wearable armor, door, wall, floor, roof, or wind turbine blade. Alternatively, a panel may form a portion of the structure. For example, a panel of the present invention may replace a panel of an outer structure of an automobile, truck, shipping container, aircraft, wearable armor, door, wall, floor, roof, or wind turbine blade. Panels may be flat, curved, contoured, or have any other geometric shape or contour.

Panels formed according to embodiments of the present invention have many applications. For example, panels may be used in applications of homeland security, environmental monitoring, defense, displays, recreational vehicles, inventory management, shipping, infrastructure, construction, transportation, energy generation, storage, distribution, and weather monitoring.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method of forming a modular polymer panel, comprising:
forming a plurality of layers, said forming including
forming at least one layer of the plurality of layers to include a nanomaterial, and
forming at least one layer of the plurality of layers to include a polymer;
arranging the plurality of layers in a stack; and
attaching together the layers in the stack to form the panel.

2. The method of claim 1, wherein said forming at least one layer of the plurality of layers to include a polymer comprises:
forming a layer as a planar layer of the polymer.

3. The method of claim 1, wherein said forming at least one layer of the plurality of layers to include a polymer comprises:
forming a ribbon from the polymer; and
including the ribbon in a layer of the plurality of layers.

4. The method of claim 3, wherein said forming a ribbon from the polymer comprises:
extruding the polymer to form the ribbon.

5. The method of claim 3, wherein said forming at least one layer of the plurality of layers to include a polymer further comprises:
weaving together a plurality of ribbons to form a layer of the plurality of layers.

6. The method of claim 1, wherein said forming at least one layer of the plurality of layers to include a polymer comprises:
weaving a plurality of fibers of the polymer to form a layer of the plurality of layers.

7. The method of claim 1, wherein said forming at least one layer of the plurality of layers to include a polymer comprises:
forming a plurality of yarn structures from a plurality of fibers of the polymer; and
weaving together the plurality of yarn structures to form a layer of the plurality of layers.

8. The method of claim 1, wherein said forming at least one layer of the plurality of layers to include a polymer comprises:
inserting a first polymer material into a mold;
adding a catalyst material to the first polymer material to cause a foam material to be produced that conforms to the shape of the mold; and
enabling the foam material to cure to generate a layer of the plurality of layers.

9. The method of claim 8, wherein said inserting comprises:
including a woven material in the mold; and
wherein said adding a catalyst material to the first polymer material to cause a foam material to be produced that conforms to the shape of the mold comprises
enabling the foam material to substantially surround the woven material; and
wherein said enabling the foam material to cure to generate the layer comprises
generating the layer to include the cured foam material and the woven material.

10. The method of claim 1, wherein said forming at least one layer of the plurality of layers to include a nanomaterial comprises:
including an electrically conductive nanomaterial in a layer of the plurality of layers to enable the layer to be electrically conductive.

11. The method of claim 1, wherein said forming a plurality of layers comprises:
forming a layer that includes a plurality of rods.

12. The method of claim 1, wherein said attaching comprises:
attaching together the layers according to a thermoforming technique or compression molding process.

13. The method of claim 1, wherein said attaching comprises:
generating a foam material between a pair of adjacent layers in the stack; and
enabling the foam material to cure to attach together the pair of adjacent layers.

14. The method of claim 1, wherein said arranging comprises:
positioning a plurality of thin sheets of thermoplastic adhesive between the plurality of layers in the stack; and
wherein said attaching comprises:
heating the stack to activate the thermoplastic adhesive.

15. The method of claim 1, further comprising:
forming a coating on a surface of an outer layer of the stack.

16. The method of claim 1, further comprising:
incorporating the panel in an article of clothing, a pre-existing structure, or a container.

17. A modular polymer panel, comprising:
a plurality of layers attached together in a stack;
wherein at least one of the layers includes a polymer, and at least one of the layers includes a nanomaterial.

18. The panel of claim 17, wherein the plurality of layers includes at least one of a planar layer of the polymer, a ribbon that includes the polymer, a plurality of ribbons of the polymer that are woven together, a plurality of fibers of the polymer that are woven together, a plurality of yarn structures that are woven together, or a plurality of rods.

19. The panel of claim 17, wherein the nanomaterial includes at least one of a nanowire, a nanotube, a nanorod, or a nanoparticle.

20. The panel of claim 17, wherein the polymer is polyurethane, polyester, acrylic, phenolic, epoxy, an elastomer, polyolefin, polypropylene, polyethylene, vinyl ester, a thermoplastic material, or a thermosetting plastic material.
